(19) United States
(12) Patent Application Publication
(10) Pub. No.: US 2024/0248469 A1
(43) Pub. Date: Jul. 25, 2024

(54) INFORMATION PROCESSING DEVICE AND METHOD

(71) Applicant: TOYOTA JIDOSHA KABUSHIKI KAISHA, Toyota-shi (JP)

(72) Inventors: Kaoru YOSHIDA, Nisshin-shi (JP); Masataka OKUDA, Toyota-shi (JP); Masatoshi KAKUTANI, Miyoshi-shi (JP); Toshiki SHINOHARA, Toyota-shi (JP); Kanade KURIYAMA, Toyota-shi (JP)

(73) Assignee: TOYOTA JIDOSHA KABUSHIKI KAISHA, Toyota-shi (JP)

(21) Appl. No.: 18/484,475

(22) Filed: Oct. 11, 2023

(30) Foreign Application Priority Data
Jan. 19, 2023 (JP) 2023-006511

(51) Int. Cl. G05D 1/00; H04W 4/44; H04W 24/02; H04W 56/00

(52) U.S. Cl. CPC G05D 1/0022; G05D 1/0027; H04W 4/44; H04W 24/02; H04W 56/0045; G05D 2201/0213

(57) ABSTRACT

An information processing device for controlling a plurality of terminals, the information processing device comprising: an acquisition unit that acquires, from a target terminal that is a terminal existing in a predetermined area among a plurality of terminals, information regarding a cycle of data processing executed in each target terminal; a determination unit that determines a cycle of data transmission shared by each target terminal based on the information regarding the cycle of data processing of each target terminal acquired by the acquisition unit; and a control unit that controls an execution timing of data processing in each target terminal based on the cycle of data transmission determined by the determination unit.

### CROSS-REFERENCE TO RELATED APPLICATION

This application claims priority to Japanese Patent Application No. 2023-006511 filed on Jan. 19, 2023, incorporated herein by reference in its entirety.

### BACKGROUND

### 1. Technical Field

The present disclosure relates to an information processing device and the like for controlling a plurality of terminals.

### 2. Description of Related Art

Japanese Unexamined Patent Application Publication No. 2017-073678 (JP 2017-073678 A) discloses a frequency calibration system in which a phase difference between a frequency generator of a master clock in a master station and a frequency generator of a calibration target clock in a slave station can be acquired in a simple way and at a low cost and an oscillation frequency of the calibration target clock can be calibrated.

### SUMMARY

In a cloud-type control system in which a terminal (slave station) such as mobility and an information processing device (master station) functioning as a control device provided on a cloud are connected via a network, execution timings of data processing may be different among a plurality of terminals. For this reason, it is desired that the information processing device control the terminals in the cloud-type control system while synchronizing the execution timings of the data processing to be executed by the terminals as well as synchronizing the times of the terminals by calibrating clock frequencies of the terminals.

The present disclosure has been made in view of the above problem, and an object of the present disclosure is to provide an information processing device and the like that are capable of synchronizing execution timings of data processing to be executed by a plurality of terminals.

In order to solve the above problem, one aspect of the disclosed technology relates to an information processing device configured to control a plurality of terminals.

The information processing device includes: an acquisition unit configured to acquire, from target terminals present in a predetermined area among the plurality of terminals, pieces of information on periods of data processing to be executed by the target terminals; a determination unit configured to determine a period of data transmission to be shared by the target terminals based on the pieces of information on the periods of the data processing of the target terminals that have been acquired by the acquisition unit; and a control unit configured to control execution timings of the data processing of the target terminals based on the period of the data transmission that has been determined by the determination unit.

According to the information processing device and the like of the present disclosure, it is possible to synchronize the execution timings of the data processing to be executed by the terminals.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic configuration diagram of a digital twin system including an information processing device according to an embodiment of the present disclosure;

FIG. 2 is a flowchart of a data transmission cycle synchronization process executed by the information processing device;

FIG. 3 is an example of an image of a control area;

FIG. 4 is an example of a data processing cycle in a plurality of terminals;

FIG. 5A relates to a method of determining a period of time for transmitting data to a plurality of terminals;

FIG. 5B relates to a method of determining a period of time for transmitting data to a plurality of terminals;

FIG. 6A shows an example of synchronizing the timing-of-data-processing of a plurality of terminals (cloud-based); and

FIG. 6B shows an example of synchronizing the timing of executing the data-processing of the plurality of terminals (local reference).

### DETAILED DESCRIPTION OF EMBODIMENTS

The information processing device of the present disclosure acquires a period of data processing executed in each terminal from a plurality of terminals to be controlled, determines a data transmission period based on the plurality of data processing periods, and suitably controls the execution timing of data processing in the plurality of terminals based on the data transmission period. By this control, it is possible to synchronize the execution timings of the data processing performed in each of the plurality of terminals. Hereinafter, an embodiment of the present disclosure will be described in detail with reference to the drawings.

### Embodiment

### Configuration

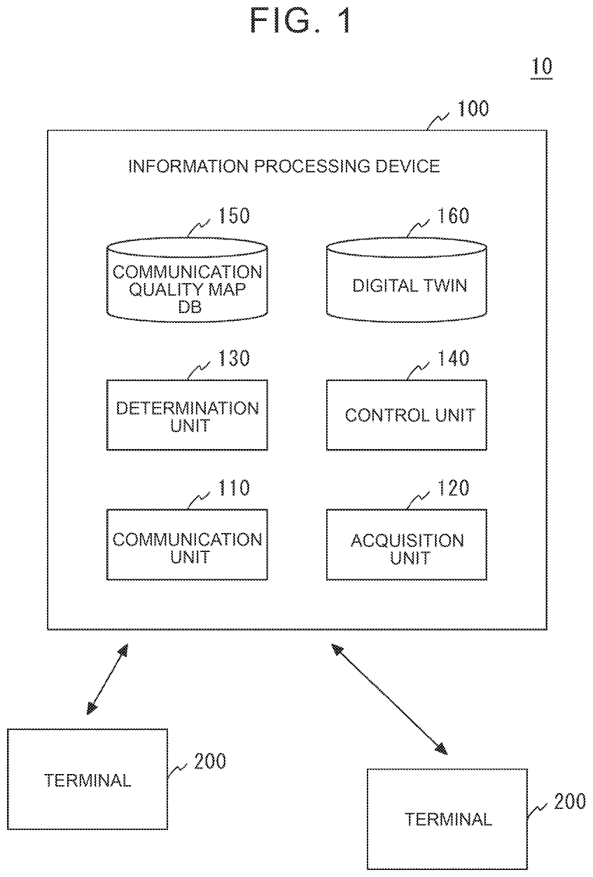

FIG. 1 is a schematic diagram of an overall configuration example of a digital twin system 10 including an information processing device 100 according to an embodiment of the present disclosure. The digital twin system 10 illustrated in FIG. 1 is a cloud-type control system, and includes an information processing device 100 and a plurality of terminals 200. The information processing device 100 and the plurality of terminals 200 are communicably connected directly or via a communication base station (not shown).

The information processing device 100 is configured to be able to communicate with a plurality of terminals 200. The information processing device 100 can provide, for example, a predetermined service to a specific terminal on the basis of data including information on a state of the terminal acquired from each of the plurality of terminals 200. Examples of the terminal 200 include mobility devices such as vehicles and mobile devices such as smartphones. When the terminal 200 is a vehicle, the information processing device 100 can provide a traffic control service to a specific terminal, for example, based on vehicle data including information on the state of the host vehicle acquired from the terminal 200. As the information processing device 100, a cloud server configured on a cloud can be exemplified.

The information processing device 100 includes a communication unit 110, an acquisition unit 120, a determination unit 130, a control unit 140, and a communication quality map database (DB) 150 and digital twin 160). The information processing device 100 is typically configured to include a processor such as a CPU (Central Processing Unit), a memory such as a RAM (Random Access Memory), a readable/writable storage medium such as a hard disk drive (HDD) or a solid state drive (SSD), an input/output interface, and the like, and realizes all or a part of the functions executed by the communication unit 110, the acquisition unit 120, the determination unit 130, and the control unit 140 by the processor reading and executing a program stored in the memory.

The communication unit 110 is a configuration for executing communication with the plurality of terminals 200. The communication unit 110 can receive, from the plurality of terminals 200, terminal data including information related to the state of the terminals, data related to the generation of the communication quality map database 150 and the digital twin 160, and the like. When the terminal 200 is a vehicle, the communication unit 110 receives, from the plurality of terminals (vehicles) 200, data including, as terminal data, information on the state of the vehicle such as the position, speed, and traveling direction of the vehicle, data on the communication quality related to the generation of the communication quality map database 150, data on the surroundings of the vehicle related to the generation of the digital twin 160, and a cycle for processing the data. In addition, the communication unit 110 can transmit (instruct) a period in which terminal data is transmitted from each terminal 200 to the information processing device 100, a timing (synchronization trigger) in which data processing is executed in each terminal 200, and the like to all or a part of the plurality of terminals 200.

The acquisition unit 120 is a configuration for acquiring, among the terminal data received from the plurality of terminals 200 by the communication unit 110, information on the cycle of the data processing executed in each target terminal 210 for the terminal 200 (hereinafter referred to as “target terminal 210”) existing in the predetermined control area. The control area is an area in which an application (not shown) that provides a predetermined service to a specific terminal needs to grasp information and data in order to realize the provision of the service. The acquisition unit 120 identifies the terminal 200 to be the target terminal 210 based on the control area, and acquires information on the data processing cycle from the identified target terminal 210. This control area will be described later. Note that the application may be implemented in the information processing device 100 or may be implemented in an application server different from the information processing device 100.

The determination unit 130 is a configuration for determining a cycle of one data transmission shared by all the target terminals 210 based on the information on the cycle of the data processing of each target terminal 210 acquired by the acquisition unit 120. The period of data transmission determined by the determination unit 130 is a period derived as an optimum solution in consideration of accuracy required for an application that provides a service based on a plurality of data processing periods. The determination unit 130 may determine the data transmission period in consideration of the information and data of the communication quality map database 150 and the digital twin 160. This data processing cycle will be described later.

The control unit 140 is a configuration for controlling the execution timing of data processing in each target terminal 210 based on the data transmission cycle determined by the determination unit 130. The control unit 140 controls the execution timing of the data processing so that the terminal data is transmitted in synchronization with the data transmission cycle from each target terminal 210. Further, the control unit 140 can determine whether the execution timing is controlled under the initiative of the information processing device 100 (cloud criteria) or under the initiative of the target terminal 210 (local criteria). The control by the control unit 140 will be described later.

The communication quality map database (DB) 150 is a configuration (storage unit) for storing/accumulating current and past communication quality information (interruptions, delays, and the like that have occurred in the current/past) at various locations, information, data, and the like related to communication quality received from the plurality of terminals 200 via the communication unit 110. Examples of the information included in the data related to the communication quality stored in the communication quality map database 150 include data and information measurement time, GPS latitude/longitude, communication line service provider name, and cell ID (Identification of a base station that relays communication, received signal strength RSSI, reference signal received power RSRP, radio wave received quality RSRQ, signal-to-interference noise ratio RSSNR, effective speed (upper-lower average/peak throughput), communication delay time, and packet loss.

The digital twin 160 is a configuration (storage function unit) for reproducing a virtual world (virtual space) time-synchronized with a real world (real space) on a cloud computer by updating (storing) data related to current and past terminal states acquired (collected) from a plurality of terminals 200 in real time. Digital twin 160 may also generate future prediction data for target terminal 210 from current and past data and information based on requests from applications. When the target terminal 210 is a vehicle, the digital twin 160 can generate a traffic digital twin in which an object (a moving object/a stationary object) on a traveling road and a traffic situation are all copied in a place (a road, a parking lot, or the like) where a plurality of vehicles participating in the digital twin system 10 can travel. Examples of the information included in the data stored in the digital twin 160 include vehicle information (such as VIN), information on other vehicles (including a bicycle, a pedestrian, and the like), map information, time information (time stamp), position information (GPS latitude/longitude), and trajectory information (vehicle speed, direction, and the like) that is a travel track.

The plurality of terminals 200 are mobility devices such as vehicles and mobile devices such as smartphones configured to be able to communicate with the information processing device 100. The terminal 200 can provide the information processing device 100 with terminal data including information related to the state of the terminal, the communication quality map database 150 constructed in the information processing device 100, and data related to the generation of the digital twin 160. The information regarding the state of the terminal when the terminal 200 is a vehicle includes the position of the vehicle, the speed of the vehicle, the traveling direction of the vehicle, and the like. Data related to the generation of the digital twin 160 when the terminal 200 is a vehicle includes data related to other than the host vehicle, such as another vehicle, a building, and a pedestrian, which are objects existing around the terminal 200. Various sensors and cameras (not shown) mounted on the terminal 200 can be used to acquire these pieces of information and data. The number of terminals 200 that communicate with the information processing device 100 is not particularly limited.

### Control

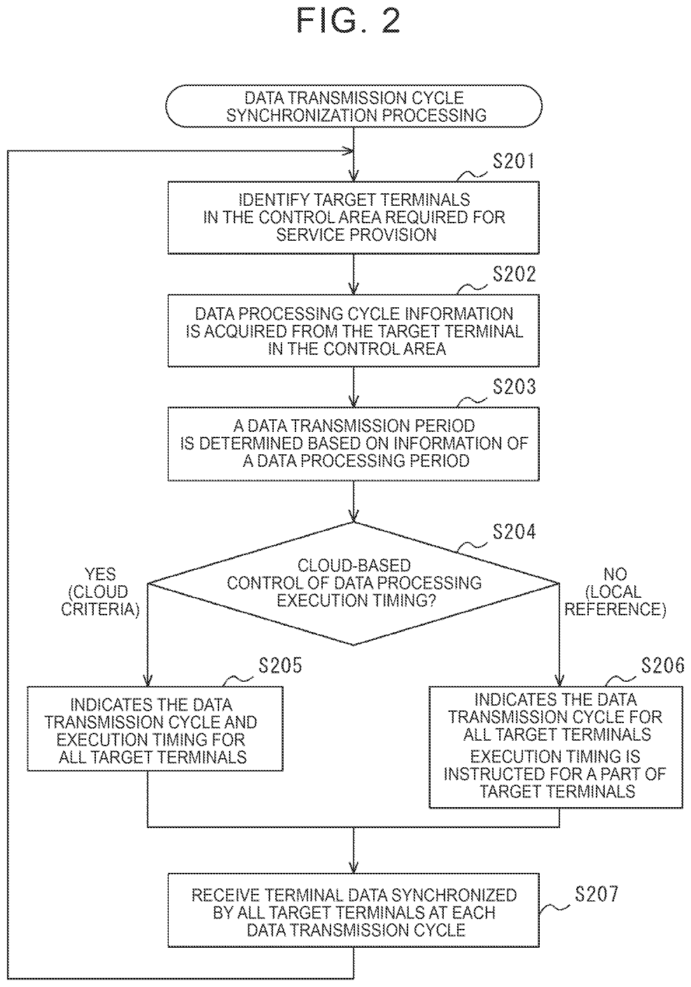

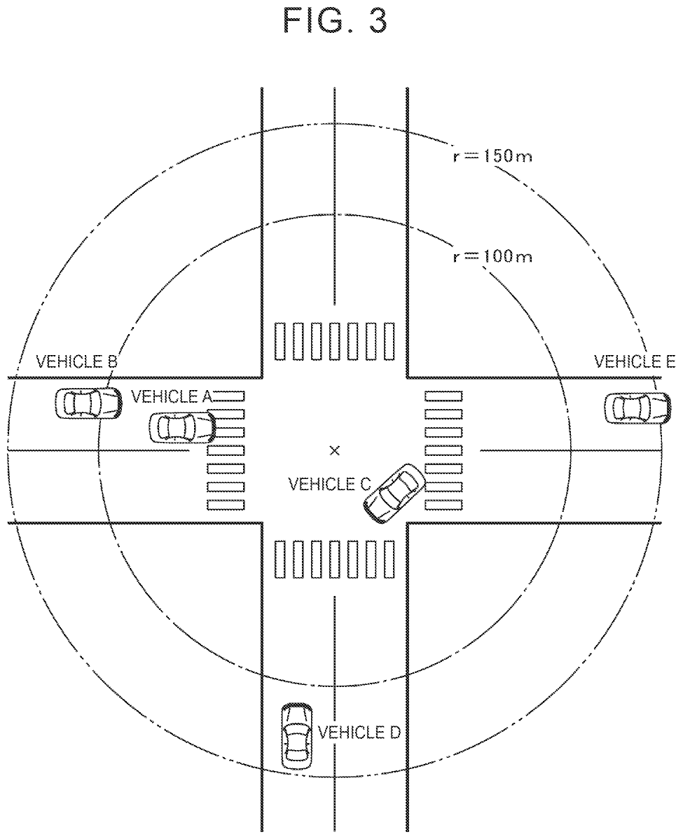

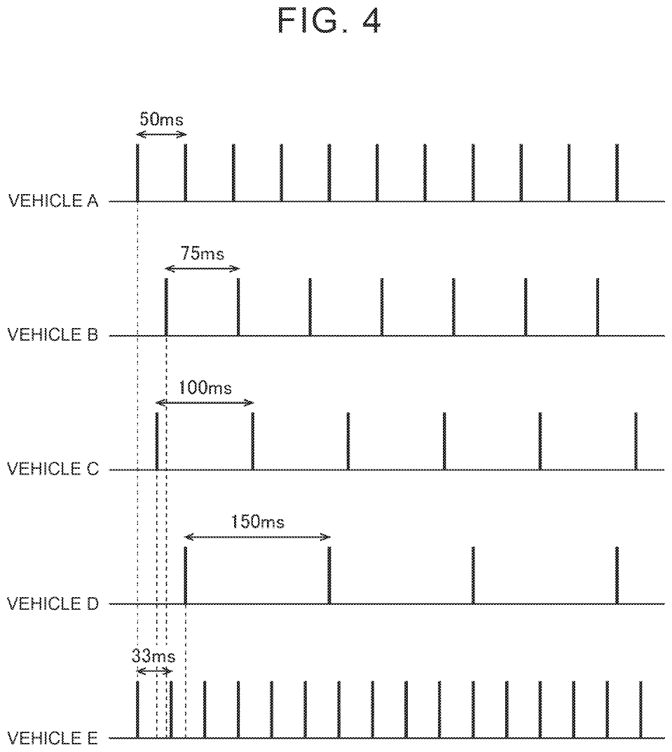

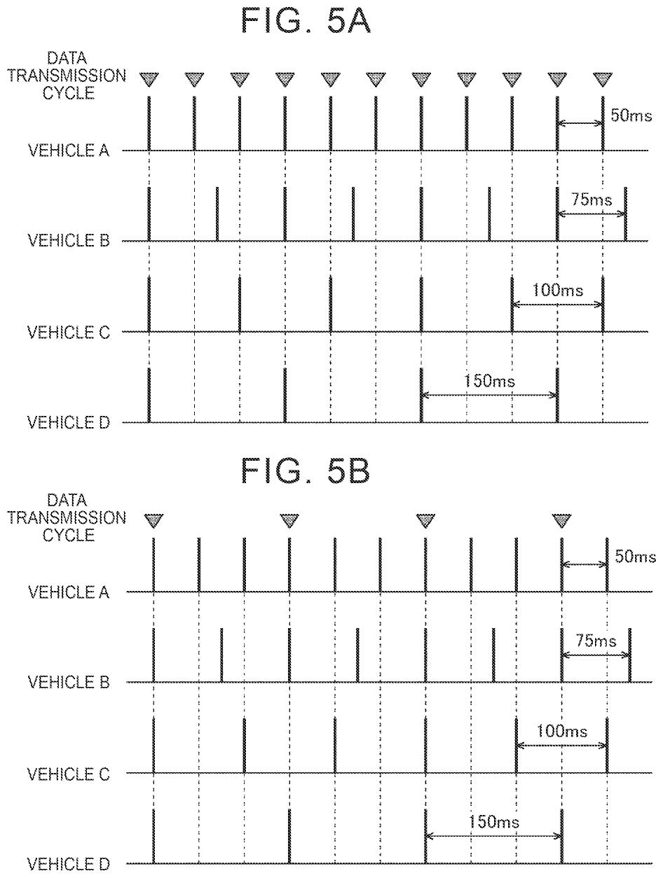

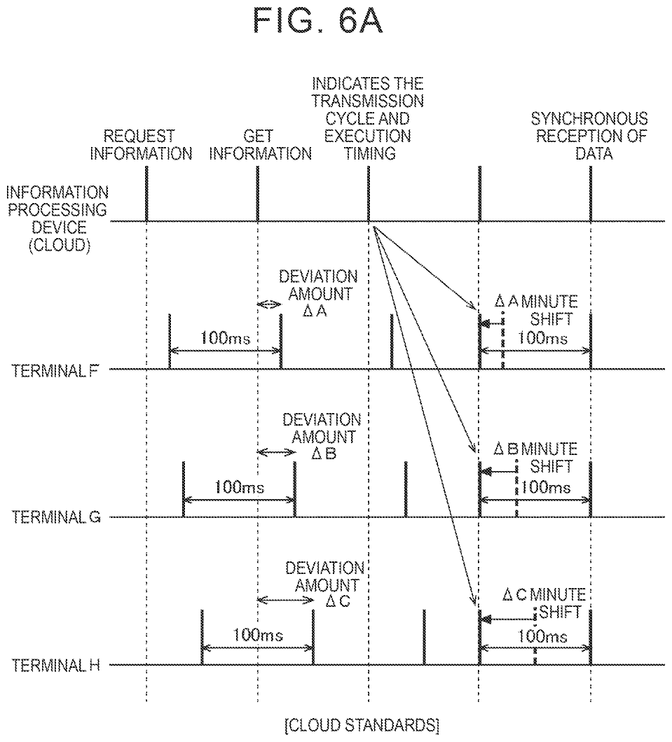

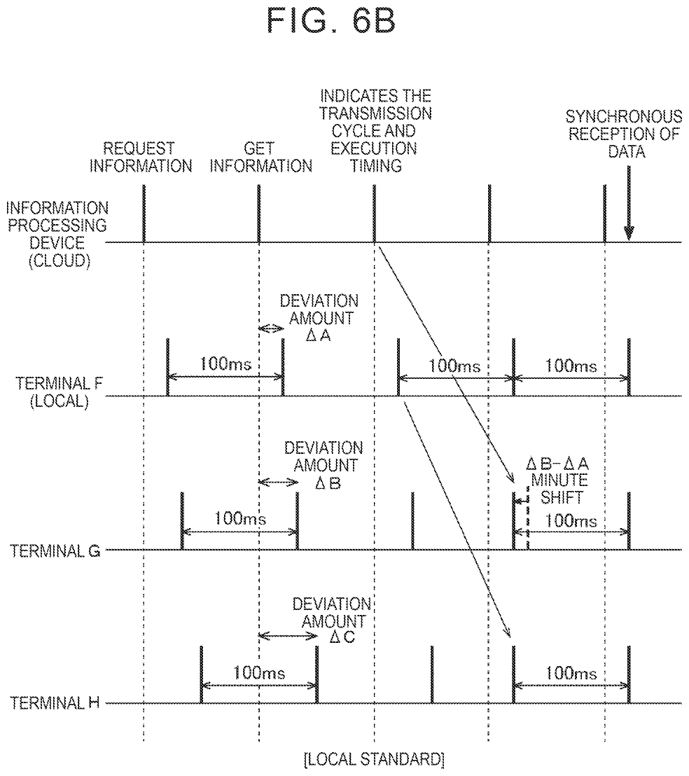

Next, the control executed by the information processing device 100 according to the present embodiment will be described with reference to FIG. 2, FIG. 3, FIG. 4, FIG. 5A, FIG. 5B, FIG. 6A, and FIG. 6B.

FIG. 2 is a flowchart of a data transmission cycle synchronization process executed by each component of the information processing device 100. The data transmission cycle synchronization process illustrated in FIG. 2 is started when a service provision request is generated from one or more applications, and is repeatedly performed until the service provision request disappears.

### S201

The acquisition unit 120 identifies the target terminal 210 existing in the control area based on the control area necessary for providing the service requested by the application. For example, in a case where the service to be provided is traffic control within an intersection with respect to the terminal 200 which is a vehicle, the target terminal 210 is specified with a region having a predetermined radius centered on the intersection as a control area. Further, for example, in a case where the service to be provided is valley parking control in a parking lot for the terminal 200 which is a vehicle, the target terminal 210 is specified as a control area such as a parking train including a floor or a space where there is a parking space.

FIG. 3 illustrates an example of an image of a control area in a traffic control service in an intersection. In the embodiment of FIG. 3, when an area having a radius r=100 m from the center of the intersection (a circle with a dashed-dotted line) is defined as a control area, the vehicle A, the vehicle B, and the vehicle C are identified as the target terminals 210. Further, in the example of FIG. 3, when the area of the radius r=150 m from the center of the intersection point (circle of the two-dot chain line) is the control area, vehicle A, vehicle B, vehicle C, vehicle D, and vehicle E is specified as the target terminal 210.

When the acquisition unit 120 identifies the target terminal 210 existing in the control area, the process proceeds to S202.

### S202

The acquisition unit 120 acquires, from the target terminals 210 that are present in the control area identified in S201, information about the period of the data-processing executed in the target terminals 210. Examples of the data processing executed by the target terminal 210 that is a vehicle include a process of detecting a physical quantity related to a vehicle state by an in-vehicle sensor or the like, and a process of capturing an image around the vehicle by an in-vehicle camera or the like. Examples of the period of the data processing include a sampling rate of the in-vehicle sensor and a frame rate of the in-vehicle camera. Examples of the data processing executed by the target terminal 210 other than the vehicle include photographing processing of a parking lot image by a fixed surveillance camera or the like. The data processing cycle can be exemplified by the frame rate of the surveillance camera.

When the acquisition unit 120 acquires information on the cycle of the data processing executed in the target terminals 210, the processing proceeds to S203.

### S203

The determination unit 130 determines the period of data transmissions to be shared by the target terminals 210 based on the information on the period of the data process executed by the target terminals 210 acquired in S202. Specifically, the determination unit 130 determines one data transmission cycle based on a plurality of data processing cycles in the plurality of target terminals 210 and information necessary for generation of the digital twin 160 and a required accuracy of a service to be provided.

FIG. 4 shows an image of the cycle and timing of data processing performed individually in vehicle A, vehicle B, vehicle C, vehicle D, and vehicle E, as exemplified in FIG. 3. In the illustration of FIG. 4, each of Vehicle A, Vehicle B, Vehicle C, Vehicle D, and Vehicle E performs data-processing at startup timing that varies by 50 ms, 75 ms, 100 ms, 150 ms, and 33 ms cycle. In this FIG. 4, for example, when the terminal data of vehicle A, vehicle B, vehicle C, and vehicle D out of the target terminal 210 is required for the service of delivery, and the acquisition period of the required terminal data is allowed to 150 ms, 50 ms (optimal solution) which is the smallest of the multiple data processing period as shown in FIG. 5A is determined as the data transmission period. In FIG. 4, for example, when the terminal data of vehicle A, vehicle B, vehicle C, and vehicle D out of the target terminal 210 is required for the delivery service, and when the acquisition period of the required terminal data is allowed within 300 ms range from 150 ms, 150 ms (optimal solution), which is the smallest data processing period within the range as shown in FIG. 5B, is determined as the data transmission period. Note that, in a case where the acquisition cycle of the allowed terminal data is less than the least common multiple of the plurality of data processing cycles, the cycle of the maximum common divisor or the minimum unit “1” of the plurality of data processing cycles is determined as the data transmission cycle.

When the determination unit 130 determines the period of data-transmission to be shared by the target terminals 210, the process proceeds to S204.

### S204

The determination unit 130 determines whether the timing at which data processing is executed in each target terminal 210 is controlled by the initiative of the information processing device 100 (cloud criteria) or the initiative of the target terminal 210 (local criteria). Specifically, the determination unit 130 refers to the communication quality map database 150 and the digital twin 160, and determines whether or not communication is possible between the terminals 200 without the information processing device 100 (whether or not inter-vehicle communication or inter-vehicle communication is possible if the terminal 200 is a vehicle), whether the communication is a cloud criterion or a local criterion is based on the possibility of occurrence of interruption or high delay in communication between the information processing device 100 and the terminal 200, the degree of weighting of control with respect to the target terminal 210, and the like.

An example of a case in which control based on a local reference is adopted is a case in which control in which real-time performance or synchronization is desired is performed. Specifically, an example is a case where an instruction is given to a control (emergency brake control or the like) having a large weight on the digital twin on the assumption that communication between the plurality of target terminals 210 without passing through the information processing device 100 is possible. Note that the plurality of target terminals 210 includes a target terminal 210 having a large weight to be a reference, and a target terminal 210 that is desired to perform cooperative control with the target terminal 210 or the infrastructure device having a large weight. Further, there is another example in which the communication quality in the control area (such as in an intersection) is low, and there is a possibility that an error in the execution timing control of the data processing becomes large due to interruption or high delay.

When the determination unit 130 determines to control the timing of executing the data processing in the target terminals 210 on a cloud basis (S204, Yes), the processing proceeds to S205. On the other hand, when the determination unit 130 determines to control the timing of executing the data processing in the target terminals 210 on a local basis (S204, No), the processing proceeds to S206.

### S205

The control unit 140 controls the timing of executing the data process in the target terminals 210 based on the data transmitting cycle determined by the determination unit 130 in the above S203 on a cloud basis. More specifically, the control unit 140 instructs all the target terminals 210 to perform a data transmission cycle and a data processing execution timing.

FIG. 6A is an image of an example in which an information processing device 100 synchronizes the timing of executing data-processing of a plurality of target terminals 210 according to a cloud standard. In this FIG. 6A, for ease of explanation, the data-processing cycles of all target terminals 210 (terminal F, terminal G, and terminal H) are 100 ms. The information processing device 100 acquires information related to data processing from all the target terminals 210, and then instructs all the target terminals 210 to execute the data transmission cycle and the data processing determined based on the information. With this instruction, the start timings of the data processing in all the target terminals 210 (terminals F, G, and H) coincide with the information processing device 100 as a reference (correcting the mutual deviation of the processing). Therefore, the information processing device 100 can receive the result when the data processing is completed from each target terminal 210 in synchronization with each other.

When the control unit 140 controls the timing of executing the data processing in the target terminals 210 on a cloud basis, the processing proceeds to S207.

### S206

The control unit 140 controls the timing of executing the data process in the target terminals 210 on the basis of the data transmitting cycle determined by the determination unit 130 in the above-described S203 on a local basis. More specifically, the control unit 140 instructs the data transmission cycle to all the target terminals 210, and instructs the execution timing of the data processing to some target terminals 210 (second target terminals). For the remaining target terminals 210 (first target terminals) for which the control unit 140 does not instruct the execution timing of the data processing, the target terminal 210 that is desired to be a reference instructs the other target terminals 210 to execute the data processing.

FIG. 6B is an image diagram illustrating an example in which a target terminal 210 and an information processing device 100 to be used as a reference are synchronized with each other according to a local reference in the timing of executing data-processing of a plurality of target terminals 210. In this FIG. 6B, for ease of explanation, the data-processing cycles of all target terminals 210 (terminal F, terminal G, and terminal H) are 100 ms. The information processing device 100 acquires information related to data processing from all the target terminals 210, and then instructs all the target terminals 210 (the terminal F, the terminal G, and the terminal H) to transmit data determined based on the information, and instructs the target terminal 210 (the terminal G) that cannot communicate between the target terminals 210 to execute data processing timing. For the target terminals 210 (terminal F and terminal H) capable of communication between terminals, the target terminal 210 (terminal F) serving as a reference instructs the other target terminal 210 (terminal H) to execute the execution timing synchronized with the execution of its own data processing. With these instructions, the start timing of the data processing in all the target terminals 210 (terminal F, terminal G, and terminal H) coincides with the start timing of the data processing based on the terminal F (correcting the mutual deviation of the processing). Therefore, the information processing device 100 can receive the result when the data processing is completed from each target terminal 210 in synchronization with each other.

In addition, for the other target terminal 210 (terminal H), information is acquired from the target terminal 210 (terminal F) which serves as a reference for weighting and cooperative control without passing through the cloud (information processing device 100). Therefore, the physical distance becomes shorter than in the case of passing through the information processing device 100 and the communication delay becomes smaller, so that it is possible to reduce the error in the execution timing adjustment with respect to the cloud reference. Note that, for the target terminal 210 (terminal G) that cannot perform inter-terminal communication for acquiring information of the target terminal 210 (terminal F) as a reference via the cloud (information processing device 100), an execution timing error equivalent to that of the cloud reference can be expected.

When the control unit 140 controls the timing of executing the data processing in the target terminals 210 on a local basis, the processing proceeds to S207.

### S207

The communication unit 110 receives, from each target terminal 210 at each data processing cycle, terminal data including a real-time result of data processing completed in a state in which all target terminals 210 are synchronized. When the communication unit 110 receives the terminal data of the target terminals 210 in synchronization with each other, the process returns to S201.

### Effects, etc.

As described above, according to the information processing device 100 and the like according to the embodiment of the present disclosure, a period of data processing executed in each target terminal 210 is acquired from the plurality of target terminals 210, a period of data transmission to the information processing device 100 shared by the plurality of target terminals 210 is determined based on the acquired data processing period and the like, and the execution timing of data processing in the plurality of target terminals 210 is suitably controlled based on the determined data transmission period and the like. By this control, it is possible to synchronize the execution timings of the data processing performed in each of the plurality of target terminals 210.

Although an embodiment of the present disclosure has been described above, the present disclosure can be regarded as an information processing device, a method executed by an information processing device including a processor and a memory, a program for executing the method, a computer-readable non-transitory storage medium storing a program, a system including an information processing device and a vehicle, and the like.

The information processing device and the like of the present disclosure can be used in a cloud-type control system or the like in which a plurality of terminals and a control device are connected via a network.

What is claimed is:

1. An information processing device configured to control a plurality of terminals, the information processing device comprising:
an acquisition unit configured to acquire, from target terminals present in a predetermined area among the plurality of terminals, pieces of information on periods of data processing to be executed by the target terminals;
a determination unit configured to determine a period of data transmission to be shared by the target terminals based on the pieces of information on the periods of the data processing of the target terminals that have been acquired by the acquisition unit; and
a control unit configured to control execution timings of the data processing of the target terminals based on the period of the data transmission that has been determined by the determination unit.

2. The information processing device according to claim 1, wherein the determination unit is configured to determine, as the period of the data transmission, a minimum period among the periods of the data processing of the target terminals.

3. The information processing device according to claim 1, wherein the determination unit is configured to determine, as the period of the data transmission, a smallest period within a predetermined range among the periods of the data processing of the target terminals.

4. The information processing device according to claim 1, wherein the determination unit is configured to determine, as the period of the data transmission, a period serving as a greatest common divisor among the periods of the data processing of the target terminals or a period of a minimum unit of one.

5. The information processing device according to claim 1, wherein the control unit is configured to give instructions for the execution timings of the data processing of all the target terminals.

6. The information processing device according to claim 1, wherein
when two or more of the target terminals are first target terminals configured to communicate between the terminals,
one of the first target terminals is configured to give an instruction for the execution timing of the data processing to the other one of the first target terminals, and
the control unit is configured to give an instruction for the execution timing of the data processing to a second target terminal other than the first target terminals.

7. The information processing device according to claim 1, wherein the determination unit is configured to determine the period of the data transmission to be shared by the target terminals based on a digital twin synchronized in time with a real space on a virtual space provided based on pieces of information acquired from the plurality of terminals and information on a communication quality of the predetermined area in addition to the pieces of information on the periods of the data processing of the target terminals.

8. A method to be executed by a computer of an information processing device configured to control a plurality of terminals, the method comprising:
a step of acquiring, from target terminals present in a predetermined area among the plurality of terminals, pieces of information on periods of data processing to be executed by the target terminals;
a step of determining a period of data transmission to be shared by the target terminals based on the acquired pieces of information on the periods of the data processing of the target terminals; and
a step of controlling execution timings of the data processing of the target terminals based on the determined period of the data transmission.
